(19) United States
(12) Patent Application Publication
(10) Pub. No.: US 2003/0160672 A1
(43) Pub. Date: Aug. 28, 2003

(54) Bistable electromagnetic valve

(76) Inventors: Hubert Ott, Ravensburg (DE); Thomas Grau, Argenbuehl (DE)

Correspondence Address: William D. Breneman, Esq., BRENEMAN & GEORGES, 3150 Commonwealth Avenue, Alexandria, VA, 22305, US

(21) Appl. No.: 10/367,829

(22) Filed: Feb. 19, 2003

(30) Foreign Application Priority Data
Feb. 19, 2002 (DE) 102 06 778.3
Apr. 16, 2002 (DE) 102 16 688.9

(51) Int. Cl. H01F 7/08

(52) U.S. Cl. 335/220

(57) ABSTRACT

What is proposed is a bistable electromagnetic valve (1) with a valve chamber (7) arranged between two pole pieces (5, 6) and with a valve body (8) which is located therein and is displaceable between two end positions and which is designed as a magnet for at least one permanent magnet (12, 13) and for at least one control coil (3), said valve being capable of being implemented in a small form of construction. This is achieved, according to the invention, in that at least one fluid duct (15) is provided as an inflow in the axial direction between the outer wall of the pole piece (5) and the valve housing (2).

### BACKGROUND OF THE INVENTION

1. Field Of The Invention

The invention relates to a bistable electromagnetic valve characterized by at least one fluid duct (15) is provided as an inflow in the axial direction between the outer wall of a pole piece (5) and the valve housing (2).

Prior art valves of this type are used, for example, in refrigerant circuits, such as are described in the publications DE 37 18 490 or EP 1 054 200.

2. Description Of The Related Art Including Information Disclosed Under 37 C.F.R. 1.97 and 1.98

In such valves, a bistable situation is achieved in that permanent magnets are arranged outside the valve housing next to the valve chamber or next to the pole pieces, so that the valve body has two end positions, in which it is held by these permanent magnets, at the pole pieces.

In this prior art, the outflow of the fluid flowing through the valve during operation takes place through a central axial bore of one pole piece or the other, depending on the switching position of the valve, one bore being opened and the other at the same time closed by the valve body.

Inflow takes place via an inflow line connected radially to the valve chamber, so that the valve is, as it were, in the shape of a T-piece.

The inflow line of such a valve restricts the possibilities for arranging the control coil.

The publication DE 37 18 490, in turn, discloses a valve arrangement, in which the inflow runs in the axial direction, but eccentrically through a corresponding bore of the pole piece. The inflow line is in this case connected in a leaktight manner to the pole piece. The effect of this arrangement is that the corresponding pole piece has a large diameter.

### BRIEF SUMMARY OF THE INVENTION

The object of the invention is, by contrast, to propose a valve which makes it possible to have a small form of construction.

Starting from a valve of the type mentioned in the field of the invention characterized by at least one fluid duct (15) that is provided as an inflow in the axial direction between the outer wall of pole piece (5) and the valve housing (2).

Advantageous versions and developments of the invention are possible as a result of features described in the following description of the invention including drawings and dependent claims.

Thus, according to the invention, at least one fluid duct is provided between the outer wall of a pole piece and the valve housing. The result of this is that a separate external connection for the inflow of the fluid does not have to be mounted in the region of the valve chamber, the consequence of this being that flexibility in the arrangement of the control coil is markedly increased. Furthermore, a form of construction with markedly smaller outer dimensions, for example with a considerably smaller diameter, is possible, since the separate bore for inflow in the pole piece is dispensed with.

Advantageously, a plurality of fluid ducts are formed, distributed circumferentially, on the outer wall of the pole piece. Owing to this, in turn, the valve body is subjected to a uniform onflow over the entire circumference in the axial direction, with the result that transverse forces on the valve body due to the fluid flow are largely ruled out.

By the fluid ducts being arranged outside the valve axis and therefore outside the effective range of the valve body, a connection unimpaired by the valve body is obtained between the inside of the valve chamber and the valve inflow. This connection gives a constantly uniform onflow of the valve chamber and, consequently, defined flow conditions and a defined flow resistance of the valve.

Preferably, a rotationally symmetric valve body is provided, on the outer wall of which is provided the fluid passage for the fluid flow in the valve housing. It is particularly advantageous, in this respect, to use a spherical valve body.

Valve bodies designed in this way can be operated, in the case of an appropriate uniform onflow in the axial direction, without circumferential guide means which enlarge the form of construction, since such valve bodies are centered by the dynamic pressure of the fluid. In particular, this is possible when the valve body is a ball, the diameter of which is smaller than the inside diameter of the valve housing. The annular gap thereby occurring on the outside serves as a fluid passage, the valve body being centered with respect to the valve axis by the fluid flow.

Good centering of the valve body is advantageous in order to ensure a good centric seat of the valve body and therefore a good sealing function in the end position.

This embodiment not only brings about a good centering of the valve body, but allows a virtually friction-free movement of a valve body inside the valve chamber, with the result that the control coil can have smaller dimensioning.

Furthermore, a ball is a valve body with very low mass, that is to say, for the bistable function of the valve, the permanent magnets can have smaller dimensioning or be arranged at a greater distance from the valve body. Moreover, lower impact pulses occur when the valve body has a smaller mass, with the result that the wear on the valve seats is reduced and the useful life of the valve is therefore increased. If appropriate, a complicated hardening of the valve seats may also be dispensed with.

One or more fluid ducts, which, according to the invention, lie outside, may be produced, for example, by the cross section of the corresponding pole piece being designed differently from the cross section of the valve housing. As regards a cross section of the valve housing in the form of a cylindrical tube, the fluid ducts may be formed, for example, by means of flattenings or incisions into the outer wall of the pole piece, by the interspaces which occur as a result.

Preferably, in this case, intermediate regions in the outer wall of the pole piece are provided, which come to bear on the valve housing, so that an exactly fitting and therefore centric seat of the pole piece in the valve housing is obtained, without further measures, in these regions.

The form of construction given above is highly compact and, as a result, has very narrow passage orifices for the fluid stream in the valve chamber. The arrangement is consequently sensitive to foreign bodies or dirt particles. A dirt filter is therefore advantageously provided for corresponding applications.

In this way, the critical structural elements, that is to say the valve body and the valve seats or, overall, the valve chamber containing the valve body, are reliably protected against the external introduction of dirt after the completion of the fluid circuit, since only purified fluid can enter the valve chamber.

Such a dirt filter may be of magnetic or mechanical design. The fluid ducts arranged on the outside make it possible, in this case, for example, for the magnets provided for the bistable action of the magnet [sic] to be mounted on the inside of the housing, so that the fluid has to pass these magnets before reaching the valve chamber. Magnetic or magnetizable dirt particles in this case settle on the magnets and are thus kept away from the interior of the valve chamber. A following mechanical filter may be formed, for example, by a spacer ring between such annular magnets, which is designed to be porous or is provided in another way with appropriately small passage orifices.

Preferably, however, the dirt filter is arranged on the inflow side of the pole piece in the valve housing. This position constitutes the arrangement, nearest to the valve chamber, for a dirt filter arranged separately from the valve chamber.

A dirt filter according to the invention may be built permanently into the valve housing, that is to say nonexchangeably or so as to be exchangeable only together with the entire valve, insofar as the filter capacity is sufficient for once-only purification of the fluid circuit.

Conventionally, filters in fluid circuits are designed in such a way that they are exchangeable or accessible for cleaning, since the filters eventually become clogged. The invention is based, however, on the further recognition that, when such a valve is always used in circuits which, as a rule, remain closed for the useful life of the valve, the possibility is afforded of building a dirt filter permanently into the valve. In this case, however, this filter must have sufficient filter capacity for a once-only purification of the entire fluid located in the circuit.

Since no further dirt load occurs at the filter after this once-only purification, clogging can be ruled out, so that there is no need to exchange or clean the filter.

In a development of the invention, a magnetic dirt filter is provided. A magnetic dirt filter is capable of retaining magnetic or magnetizable dirt particles which, for example, may be flushed off on the inner wall of the pipes of the refrigerant circuit or may pass into the inside of the fluid circuit during the assembly of the circuit, for example by soldering. However, it is precisely these magnetic or magnetizable dirt particles which are particularly critical in terms of malfunctions, since, without prior retention measures, these particles remain in the valve chamber due to the permanent magnets necessary for the bistable design and permanently impair the leaktightness of the valve there and at the same time increase wear.

A magnetic dirt filter is particularly effective when it is in direct contact with fluid. Consequently, in a particularly advantageous embodiment of the invention, a permanent magnet is arranged within the valve housing or within the connecting line of the latter.

In a development of this embodiment, an annular magnet is provided as dirt filter. Annular magnets are available at moderate cost in the trade and, along with good assembly possibilities inside a round tube, afford a large surface capable of being laden with the dirt particles, while at the same time there is a sufficiently large flow cross section for the fluid, for example refrigerant.

In another embodiment of the invention, a mechanical filter alone or in combination with a magnetic filter is provided. A mechanical filter is capable of retaining even nonmagnetic or nonmagnetizable dirt particles and therefore of ensuring a more complete purification of the refrigerant.

The combination of a mechanical filter with a magnetic filter preceding the latter with respect to the direction of flow is particularly advantageous, since, by the prefiltering of the magnetic or magnetizable dirt particles, the load on the mechanical filter is reduced, so that its dimensioning can be made smaller.

In an advantageous embodiment, the magnetic filter is used at the same time as a mounting for the mechanical filter, so that a separate mounting at the location of the magnetic filter may be dispensed with.

Particularly in combination with an annular magnet, the mechanical filter is designed preferably as a tubular sieve. Such a tubular sieve may have slipped onto it, for example, an annular magnet which comes to bear with an exact fit on the inner wall of the inflow to the valve chamber. In this way, on the one hand, the tubular sieve is fixed at this point and, on the other hand, the cross section of the inflow outside the tubular sieve is closed by the annular magnet, so that the fluid can flow only into the interior of the tubular sieve.

Particularly in conjunction with the abovementioned features, the interior of the tubular sieve is connected to the inflow of the fluid, for example of the refrigerant, and the exterior of the tubular sieve is connected to the valve chamber. In this case, the retained dirt particles accumulate in the interior of the tubular sieve, while, if appropriate, magnetic or magnetizable particles are already retained on the permanent magnet, as indicated above.

Moreover, the use of a tubular sieve as a mechanical filter affords, in addition to the abovementioned favorable arrangement upstream of the valve chamber (as seen in the direction of flow), the possibility that the selected filter capacity can be sufficiently large owing to a corresponding axial length of the tubular sieve.

### BRIEF DESCRIPTION OF THE INVENTION

An exemplary embodiment of the invention is illustrated in the drawing and is explained in more detail below with reference to the figures of which, in particular,

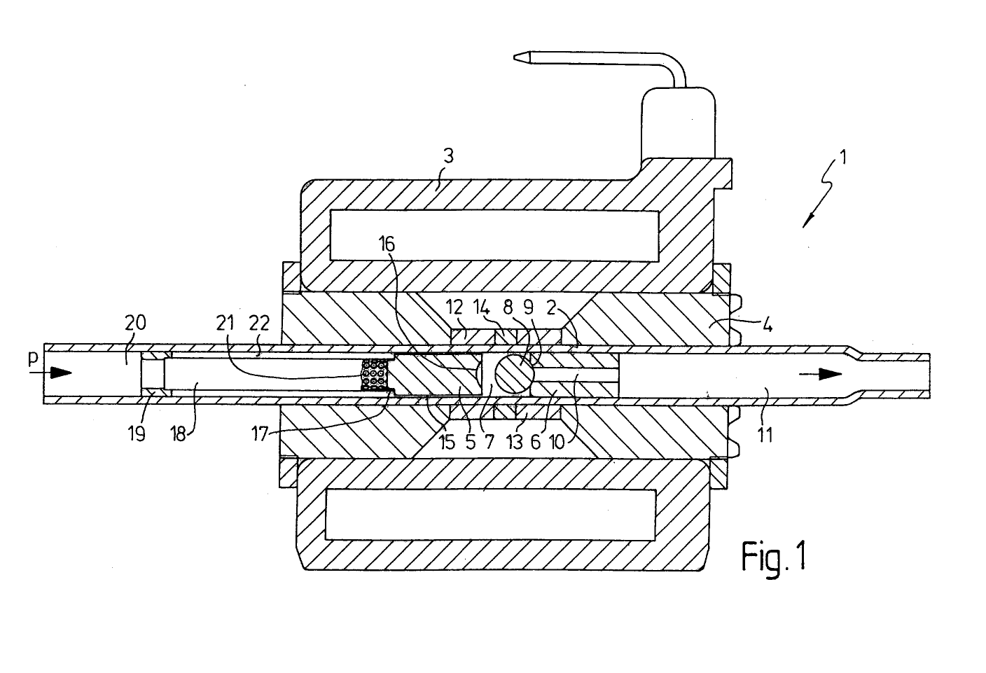

FIG. 1 shows a cross section through a 2/2-way valve according to the invention,

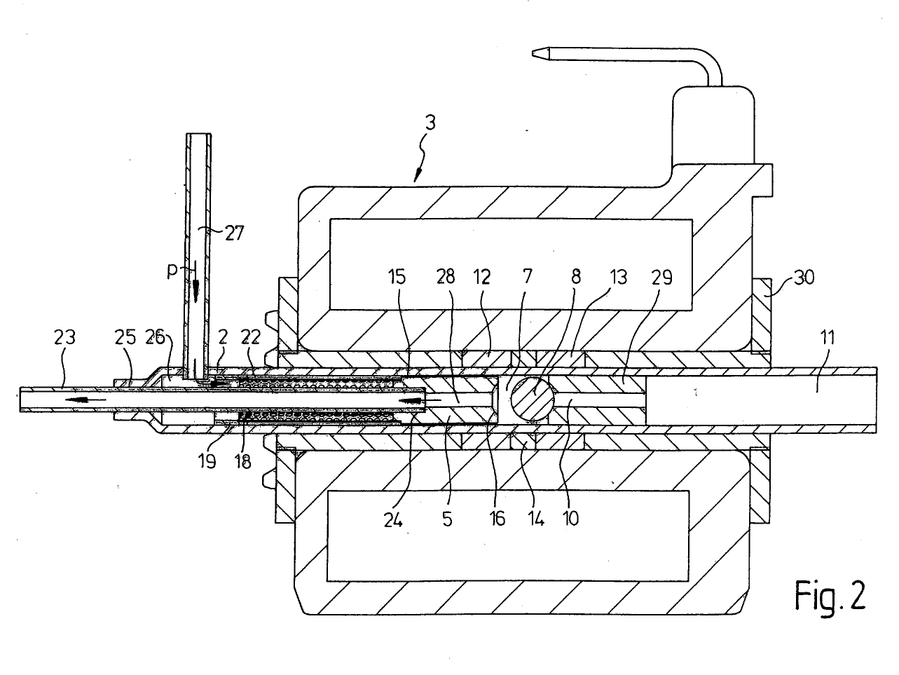

FIG. 2 shows a cross section through a 3/2-way valve according to the invention,

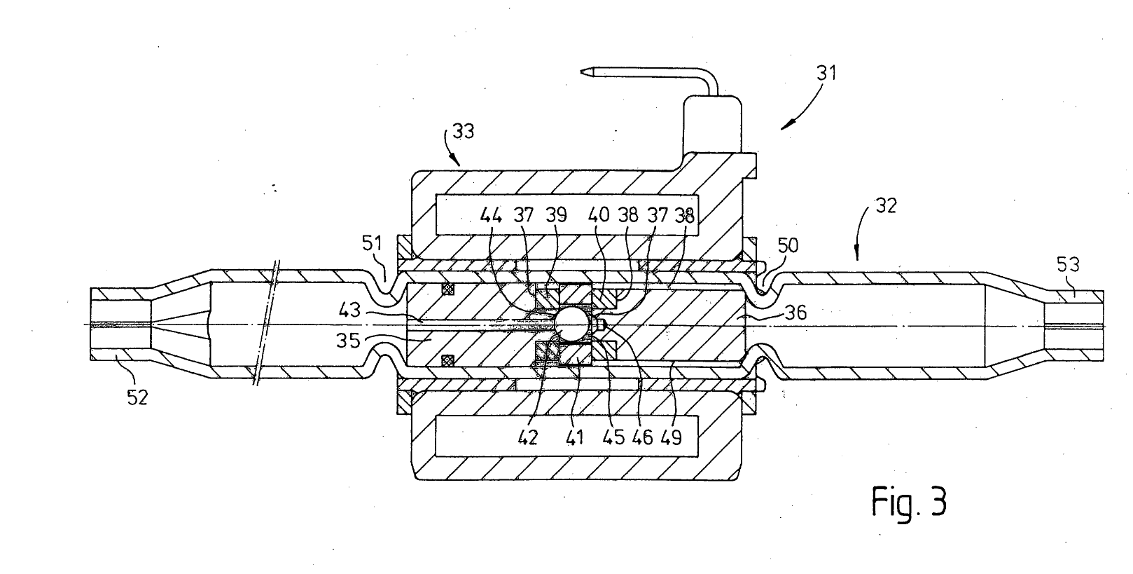

FIG. 3 shows a cross section through a further exemplary embodiment of a 2/2-way valve according to the invention, and

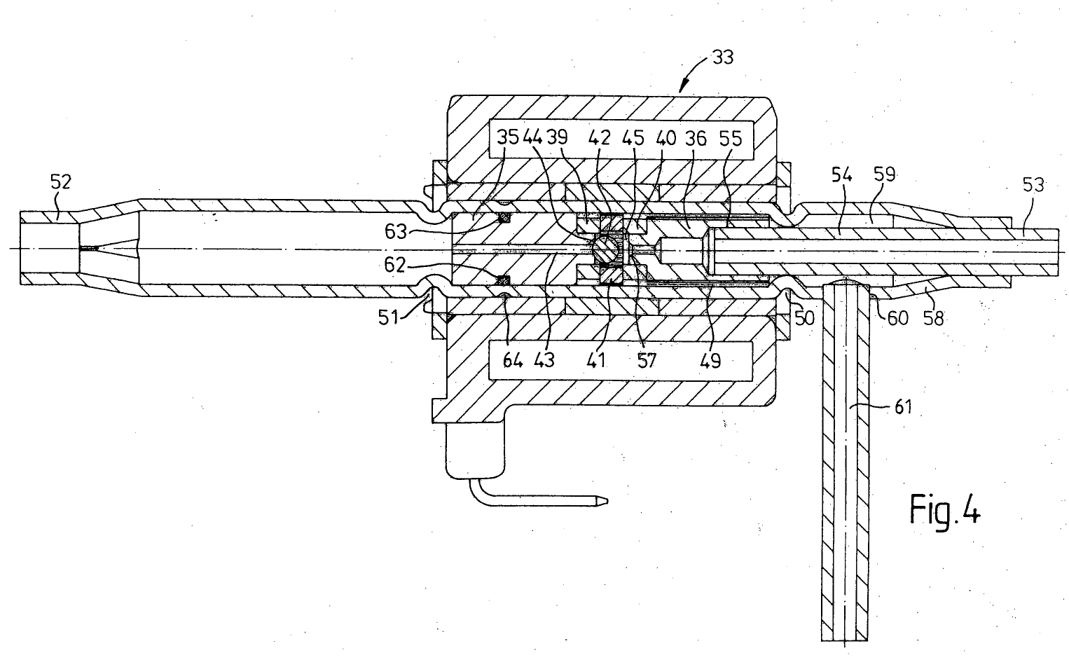

FIG. 4 shows a cross section through a further exemplary embodiment of a 3/2-way valve according to the invention.

### DETAILED DESCRIPTION OF THE INVENTION

The valve 1 according to FIG. 1 comprises a tubular valve housing 2 which presses completely through a control coil 3. Adapter pieces 4 in this case ensure a good fit in the valve housing 2 and are designed at the same time as flux guide elements for an increased magnetic flux through pole pieces 5, 6 and through a valve chamber 7. Inside the valve chamber 7 is located a spherical valve body 8 which, in the position illustrated, lies on the spherical seat 9 of the pole piece 6 and at the same time closes a passage bore 10. The passage bore 10 issues into the outflow line 11 of the valve 1.

Annular magnets 12, 13 lying outside the valve housing 2 ensure the bistable behavior of the valve and are fixed by means of a spacer ring 14 between the adapter pieces 4.

The pole piece 5 has, on its outer circumference, recesses or flattenings which result in fluid ducts 15 according to the invention between the pole piece 5 and the valve housing 2 into the inside of the valve chamber 7. The fluid ducts could also be implemented by bores in the pole piece 5, the inflow-side orifices of said bores lying in the annular region between a tubular sieve 18 and the outer wall of the valve housing 2. The pole piece 5 has, furthermore, a spherical seat 16, in order to bring about a defined end position of the valve body 8 in the second end position, not illustrated.

The pole piece 5 comprises a step 17, onto which the tubular sieve 18 is pushed. At the opposite end, the tubular sieve 18 is fixed in a magnetic filter 19 designed as an annular magnet. The tubular region of the valve housing 2 in which the tubular sieve 18 and the magnetic filter 19 are located serves as an inflow line 20 for the corresponding fluid, that is to say, in particular, for refrigerant.

Inflowing fluid (see arrow P) first enters the region of the magnetic filter 19, which is designed as an annular magnet, and comes directly into contact with the fluid. As a result, magnetic or magnetizable dirt particles are already fixed permanently on the magnetic filter 19 at a considerable distance from the valve chamber 7.

The fluid subsequently passes into the inside the tubular sieve 18 which is closed on the end face, at the opposite end, by the pole piece or its step 17. The fluid flow therefore has to take place radially outward in the tubular sieve 18, dirt particles larger than the sieve orifices 21 of the tubular sieve 18 being retained in the interior of the tubular sieve 18. Thus, only purified fluid passes into the exterior 22 between the tubular sieve 18 and the valve housing 2. The fluid passes from there, via the fluid ducts 15, into the inside of the valve chamber 7.

The flow takes place, of course, only with the valve open, that is to say in the switching position in which the valve body 8 lies on the spherical seat 16 and the passage bore 10 is released.

A valve 1 according to the invention can easily be built into a fluid circuit, for example a refrigerant circuit, which, as a consequence of manufacture, contains dirt particles which are not compatible with conventional refrigerant valves and cause malfunctions.

The use of the valve 1 is aimed at closed fluid circuits which remain closed after manufacture over the useful life of the valve 1. The filter capacity of the filter system consisting of the tubular filter 18 and of the magnetic filter 19 must in this case be designed in such a way that once-only complete purification of the fluid located in the circuit, without clogging, can follow.

In this way, that is to say by the use of a filter 18, 19 in the inflow line 20 of the valve housing 2 and, in particular, by the direct arrangement next to the valve chamber 7, an introduction of dirt into the valve chamber 7 is reliably ruled out insofar as permanently leaktight and low-wear functioning of the valve 1 can be ensured.

FIG. 2 corresponds essentially to the abovementioned exemplary embodiment, in this case, by contrast, a second tubular outflow line 23 being lead into the inside of the valve housing 2 as far as the pole piece 5 and being fixed in a leaktight manner there in a corresponding bore 24. The valve housing 2 and the outflow line 23 are closed off, leaktight, relative to one another, for example pressed together or soldered together, at a sealing point 25.

An interspace 26 is thus obtained between the outflow line 23 and the valve housing 2, an inflow line 27 being connected to said interspace. The inflow line 27 may, for example, be soldered in a corresponding orifice of the valve housing 2.

In this embodiment, the pole piece 5 also comprises a passage bore 28 which connects the valve chamber 7 to the interspace 26 via the fluid ducts 15.

The fluid or refrigerant can pass in the direction of the arrow P into the interspace 26 and from there through the magnetic filter 19 into the in this case annular interior between the tubular sieve 18 and the outflow line 23. The fluid subsequently flows radially outward into the exterior 22 between the tubular sieve 18 and the valve housing 2, from where it passes via the fluid ducts 15 into the valve chamber 7.

Depending on the switching position of the valve body 8, the fluid then flows out either via the outflow line 23 or via the outflow line 11. In the switching position illustrated, the passage bore 28 of the pole piece 5 is open, that is to say outflow takes place via the outflow line 23.

By means of a control pulse from the control coil 3, the valve body 8 can be brought onto the opposite spherical seat 16, with the result that the passage bore 28 is closed and the passage bore 10 is opened. In this switching position described, but not illustrated, the fluid flows out via the outflow line 11.

Instead of the adapter pieces 4, which have a conical outflow surface inside the control coil 3, in this case sleeve-shaped flux guide plates 29 for guiding the magnetic flux inside the control coil 3 are provided, which completely fill the interspace between the valve housing 2 and the control coil 3. The flux guide plates 29 are connected in each case to a closing plate 30 which itself is connected to what are known as yoke plates, not illustrated in any more detail, or merges into these. The flux guide plates 29 may be punched, together with the closing plate 30 and the entire yoke plate arrangement, not illustrated in any more detail, out of a flat material and bent or wound.

FIG. 3 shows a further version of the invention which differs in various features from the exemplary embodiments described above.

In particular, these features are two pole pieces 35, 36 which each have an annular shoulder 37, 38 at their inner end. Two permanent magnets 39, 40 which are designed as annular magnets are pushed onto the pole pieces 35, 36 until they butt against the annular shoulders 37, 38. Between the permanent magnets 39, 40 is inserted a spacer ring 41 which serves at the same time as a filter element and guide ring for a spherical valve body 42. The valve body 42 is produced from a magnetic or magnetizable material and thus serves directly as a valve armature. In a pole piece 35, a passage bore 43 is formed, which issues inside the valve chamber 45 in an in this case spherical valve seat 44 which, however, may also be designed otherwise, for example as a conical seat. The opposite pole piece 36 has only a blind bore 46 with an end-face conical seat 47 which may likewise also be designed otherwise, for example as a spherical seat, for the valve body 42.

The pole piece 36 is provided on the outside with flattenings 48, so that, again, the fluid ducts 49 between the pole piece 36 and the valve housing 32 are formed at this point. All the inner structural elements of the valve 31 are pressed together in the valve housing 32, and thus fixed in the axial direction, between two beads 50, 51 running all-round.

Mounted on the valve housing 32 on the end faces are two connecting tubes 52, 53, by means of which the valve can be connected to the respective fluid circuit. The connecting tubes 52, 53 are integrally formed in one piece onto the valve housing 32 in the present exemplary embodiment, so that there is no connection point and there is [sic] therefore no sealing problems at this point.

The fluid supply of the valve 31 according to FIG. 3 takes place via the connecting tube 53. The fluid passes through the fluid ducts 49 between the pole piece 36 and the valve housing 32 into the region of the valve chamber 45. In this case, it flows on the outside first along the permanent magnet 40 and then passes into the spacer ring 41 which is permeable both in the radial and the axial direction. The flow thereby also passes onto the opposite permanent magnet 39. The permanent magnets 39, 40 have outside diameters smaller than the inside diameter of the valve housing 32, so that sufficient space remains between the permanent magnets 39, 40 and the valve housing 32 for the fluid flow and for the deposit of magnetic dirt particles. The spacer ring 41 serves, moreover, as a mechanical filter element, in order to retain nonmagnetic dirt particles from the fluid before they penetrate into the inside of the valve chamber 45. The spacer ring 41 at the same time affords a guide for the spherical valve body 42.

In the illustrated switching position of the valve 31, the 2/2-way valve is closed, that is to say the valve body 42 is seated on the valve seat 44 and seals off the passage bore 43. By action upon the control coil 33, the valve body 42 can be switched into the opposite position, in which it butts against the spherical seat 47 and thus opens the passage bore 43 toward the interior of the valve chamber 45. In this switching position, the fluid can flow through the passage bore 43 as far as the connecting tube 52.

The valve arrangement according to FIG. 4 corresponds essentially to the exemplary embodiment described above. The difference is that the valve according to FIG. 4 is designed as a 3/2-way valve.

For this purpose, a central tube 54 is inserted into the connecting tube 53 and extends as far as the pole piece 36 which is provided with a receiving bore 55 in order to receive the central tube 54.

The receiving bore 55 in the pole piece 36 is prolonged via a passage bore 56 into the inside of the valve chamber 45. In the region of issue is mounted, in the pole piece 36, a, for example, spherical or conical valve seat 57 which is opened or closed alternately with the valve seat 44, depending on the switching position of the valve.

Between the central tube 54 and the housing region 58 an interspace 59 is obtained which is connected to a delivery line 61 via a bore 60.

Furthermore, in the embodiment illustrated, a sealing element 62 is inserted in an annular groove 63 of the pole piece 35 and, as can be seen from an outer bead 64, is pressed or soldered.

The 3/2-way valve according to FIG. 2 possesses a delivery line 61 and two outlet lines. As in the exemplary embodiment mentioned above, one of the outlet lines is formed by the connecting tube 52, but the other outlet line is formed in this case by the connecting tube 53 which served as a delivery line in the 2/2-way version.

Delivery takes place via the interspace 59 toward the fluid ducts 49. As in the exemplary embodiment mentioned above, the flow passes onto the permanent magnets 39, 40 and onto the spacer and guide ring 41. Here, too, the permanent magnets 39 and 40 act as magnetic filter elements, in order to retain magnetic dirt particles, while the spacer and guide ring 41 is designed as a filter ring which is fluid-permeable in the radial and in the axial direction. The fluid thereby passes into the inside of the valve chamber 45.

The fluid can then escape either through the passage bore 43 or, depending on the switching position of the valve, through the passage bore 56. In the switching position illustrated, the valve seat 44 is closed by the valve body 42, while the valve seat 57 is open. In this switching position, therefore, the fluid flow runs toward the outlet line 53.

After the changeover with the aid of a control pulse through the control coil 33, the valve seat 55 is closed and at the same time the valve seat 44 is opened, so that the fluid flow takes place via the passage bore 43 toward the connecting tube 52. The mode of action of the control coil 33 and of the permanent magnets 39 and 40 correspond in this case entirely to the exemplary embodiment mentioned above.

As illustrated with reference to the sealing element 62, care must be taken to ensure as leaktight a closure as possible between the one pole piece 35 and the valve housing 32. This is implemented, merely by way of example, with the aid of an annular sealing element. Surface pressing or soldering could also be provided. Such an arrangement would correspond to the exemplary embodiment illustrated by means of FIG. 3.

Correspondingly, the central tube 54 is to be sealed off relative to the pole piece 36. Here, too, if required, a sealing element may be inserted in a way not illustrated in any more detail. In the embodiment according to FIG. 4, the central tube 54 comes to bear over its area, so that a leaktight closure by pressing or soldering is obtained.

As can be seen from FIG. 4, the central tube 54 can be fixed both in the axial and in the radial direction by pressing or soldering, this being made clear by the bead 50 bearing on the central tube 54. In this case, care is taken to ensure that the bead 50 does not come to bear all-round, so that a sufficient passage between the interspace 59 and the fluid ducts 49 always remains open.

List of Reference Symbols:

1 Valve

2 Valve housing

3 Star coil [sic]

4 Adapter pieces

5 Pole piece

6 Pole piece

7 Valve chamber

8 Valve body

9 Spherical seat

10 Passage bore

11 Outflow line

12 Annular magnet

13 Annular magnet

14 Spacer ring

15 Fluid duct

16 Spherical seat

17 Step

18 Tubular sieve

19 Magnetic filter

20 Inflow line

21 Sieve orifice

22 Exterior

23 Outflow line

24 Bore

25 Sealing point

26 Interspace

27 Inflow line

28 Passage bore

29 Flux guide plate

30 Closing plate

31 Valve

32 Valve housing

33 Control coil

34 Pole piece

35 Pole piece

36 Annular shoulder

37 Annular shoulder

38 Permanent magnet

39 Permanent magnet

40 Spacer ring

41 Valve body

42 Passage bore

43 Valve seat

44 Valve chamber

45 Blind bore

46 Spherical seat

47 Flattening

48 Fluid duct

49 Bead

50 Bead

51 Connecting tube

52 Connecting tube

53 Central tube

54 Receiving bore

55 Passage bore

56 Valve seat

57 Housing region

58 Interspace

59 Bore

60 Delivery line

61 Sealing element

62 Annular groove

63 Bead

What is claimed is:

1. Bistable electromagnetic valve with a valve chamber arranged between two pole pieces and with a valve body which is located therein and is displaceable between two end positions and which is designed as a magnet for at least one permanent magnet and for at least one control coil, characterized in that at least one fluid duct (15) is provided as an inflow in the axial direction between the outer wall of the pole piece (5) and the valve housing (2).

2. Valve according to claim 1, characterized in that a plurality of fluid ducts (15) are provided so as to be distributed circumferentially on the pole piece (5).

3. Valve according to one of abovementioned claims, characterized in that the cross section of the pole piece (5) having the fluid ducts differs from the cross section of the valve housing (2).

4. Valve according to one of the abovementioned claims, characterized in that intermediate regions, which come to bear on the valve housing (2), are provided on the pole piece between the fluid ducts (15).

5. Valve according to one of the abovementioned claims, characterized in that the valve body (8) is of rotationally symmetric design.

6. Valve according to one of the abovementioned claims, characterized in that the valve body (8) is a ball.

7. Valve according to one of the abovementioned claims, characterized in that a dirt filter (18, 19) is provided on the inflow side upstream of the valve chamber.

8. Valve according to one of the abovementioned claims, characterized in that the dirt filter (18, 19) is arranged directly next to a pole piece (5).

9. Valve according to one of the abovementioned claims, characterized in that the dirt filter (18, 19) is built permanently in the valve housing (2).

10. Valve according to one of the abovementioned claims, characterized in that a magnetic dirt filter (19) is provided.

11. Valve according to one of the abovementioned claims, characterized in that a mechanical filter (18) is provided.

12. Valve according to one of the abovementioned claims, characterized in that a mechanical filter (18) and a magnetic filter (19) are provided.

13. Valve according to one of the abovementioned claims, characterized in that the mechanical filter (18) is designed as a tubular sieve.

14. Valve according to one of the abovementioned claims, characterized in that the interior of the tubular sieve (18) is connected to the inflow (20) and the exterior (22) is connected via the at least one fluid duct to the valve chamber (7).

15. Valve according to one of the abovementioned claims, characterized in that the magnetic filter (19) is arranged on the inflow side (20) of the mechanical sieve (18).

16. Valve according to one of the abovementioned claims, characterized in that the permanent magnets are arranged outside the valve chamber.

17. Valve according to one of the abovementioned claims, characterized in that magnetic flux guide sleeves are provided inside the coil.

18. Valve according to one of the abovementioned claims, characterized in that the flux guide sleeves are wound from sheet metal.

19. Cold-generating circuit for a refrigerating system, in particular with a plurality of refrigerating spaces, a compressor, a condenser, a plurality of evaporators which are assigned to at least one of the refrigerating spaces, and at least one electrical control valve for connecting the condenser to one or more of the evaporators according to predetermined operating modes, characterized in that the control valve (1) is designed according to one of the abovementioned claims.

20. Domestic appliance with a cold-generating circuit, in particular refrigerator or freezer, characterized in that a cold-generating circuit having a valve according to one of claims 1 to 18 is provided.
